(19) United States
(12) Patent Application Publication
(10) Pub. No.: US 2012/0018690 A1
(43) Pub. Date: Jan. 26, 2012

(54) CARABINEER WITH PULLEY WHEEL

(75) Inventors: Paul R. Maire, Snowmass, CO (US); Michael H. Miller, Minneapolis, MN (US)

(73) Assignee: TIE BOSS LLC, Minneapolis, MN (US)

(21) Appl. No.: 13/189,795

(22) Filed: Jul. 25, 2011

Related U.S. Application Data
(60) Provisional application No. 61/367,289, filed on Jul. 23, 2010.

(51) Int. Cl. B66D 3/04

(52) U.S. Cl. 254/413; 254/390

(57) ABSTRACT

A carabineer assembly is provided. The carabineer assembly includes a wheel having a central bore. The carabineer assembly includes a carabineer having a frame, wherein a portion of the frame forms a wheel axle that extends through the central bore. In some cases, the wheel comprises a first wheel half and a second wheel half, wherein the first wheel half and the second wheel half are configured to mate together to form a wheel having a central bore.

### BACKGROUND

Carabineers are used in a variety of industries. In many situations, one end of a carabineer is fixedly attached to an object (e.g., a hook in a rock), while a rope is pulled through the other end in order to lift/maintain/lower an object (e.g., a climber). As the rope is pulled through the carabineer end, frictional forces between the rope and the carabineer end provide resistance to the pulling. In many instances, it is desirable to reduce that resistance without compromising the safety features provided by the carabineer.

### SUMMARY

Embodiments of the present invention incorporate a wheel into a conventional carabineer frame to create a carabineer assembly. In preferred embodiments, a portion of the carabineer frame itself serves as the wheel axle. In some such embodiments, the wheel is specially configured to accommodate the carabineer frame as its axle. Because no structural modifications to the carabineer frame need to be made in most embodiments, wheels can be retrofitted to existing carabineers. In some preferred embodiments, two or more wheel sections can be positioned proximate a portion of the carabineer frame, with the wheel's central bore aligned with the frame, and the two or more sections can be mated together to form a carabineer assembly in which the wheel rotates about the relevant portion of the frame.

### BRIEF DESCRIPTION OF THE DRAWINGS

FIG. 1 is a front view of a carabineer assembly including a carabineer and a wheel according to embodiments of the present invention.

FIG. 2 is a perspective view of a first wheel half according to embodiments of the present invention.

FIG. 3 is a perspective view of a second wheel half that is complementary to the first wheel half of FIG. 2 according to embodiments of the present invention.

FIG. 4 is a perspective view of a wheel including the wheel halves of FIGS. 2 and 3 according to embodiments of the present invention.

FIG. 5 is a perspective view of a first wheel half according to embodiments of the present invention.

FIG. 6 is a perspective view of a second wheel half that is identical to the first wheel half of FIG. 5 according to embodiments of the present invention.

FIG. 7 is a side view of the second wheel half of FIG. 6 according to embodiments of the present invention.

FIG. 8 is an end view of the second wheel half of FIG. 6 according to embodiments of the present invention.

FIG. 9 is a perspective view of a carabineer assembly including a carabineer and the wheel halves of FIGS. 5 and 6 in an unassembled form according to embodiments of the present invention.

FIG. 10 is a perspective view of the carabineer assembly of FIG. 9 in an assembled form according to embodiments of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

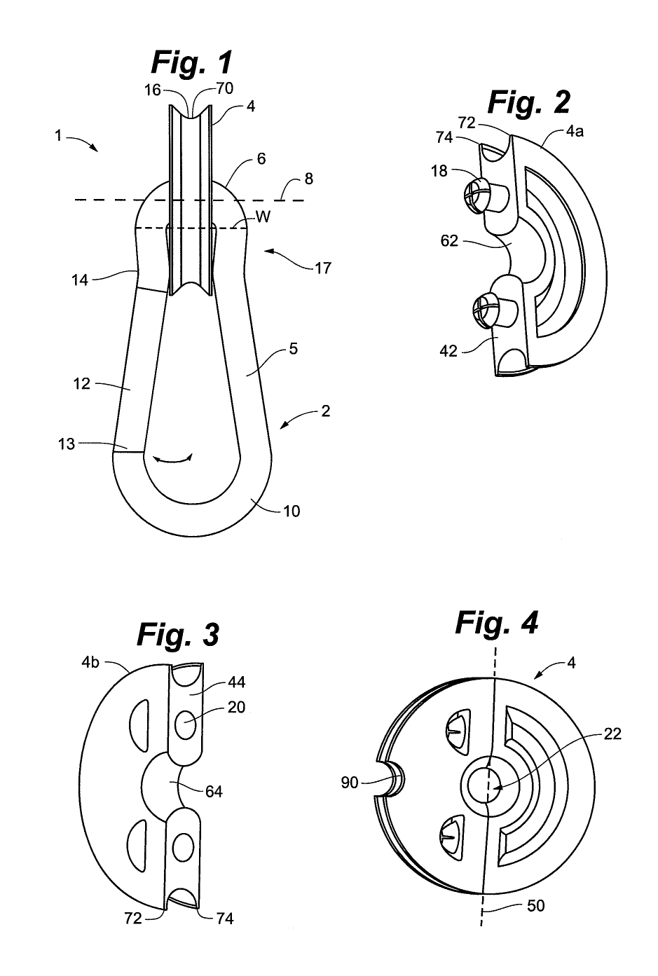

FIG. 1 shows a carabineer assembly 1 according to embodiments of the present invention. The carabineer assembly 1 includes a carabineer 2 and a wheel 4. The wheel 4 is incorporated into the carabineer 2. As used herein, the term “wheel” includes pulleys, sheaves, disks, sprockets, rollers and other generally circular or cylindrical devices. The wheel 4 is also configured to receive and support a rope. As used herein, the term “rope” includes any structure that is used like a rope, such as a fabric rope, metallic rope, chain, sling, cable, wire and the like.

The carabineer 2 can take a variety of forms and shapes, as carabineers are well known for many uses such as climbing, repelling, sailing, camping, as well as hanging and lifting a variety of items. For example, the carabineer 2 can have an oval shape, D shape, C shape, pear shape, or irregular shape. The carabineer 2 of FIG. 1 has a frame that includes a first end section 6, a second end section 10 and two side members 5, 12. The first end section 6 includes a neck region 17 that is narrower than any region of the second end section 10. The first end section 6 is also the end section that is commonly used to receive a rope. The side members 5, 12 are often generally straight and serve to provide a closed hook.

A variety of known opening and closing mechanism can be used to open and close the carabineer 2. For example, one of the side members 5, 12 can be configured to open and close the carabineer 2. In the illustrated embodiment, the side member 12 is configured as a gate that is movable between an open position and a closed position. FIG. 1 shows the gate 12 in a closed position. Generally, the gate 12 includes a free end 13 and a hinged end 14. The hinged end 14 is hingedly connected to the first end section 6. The free end 13 can be moved in accordance with the arrow shown in FIG. 1 to open and close the carabineer 2. In some cases, the free end 13 is biased towards and held in the closed position by a biasing mechanism. In other cases, the free end 13 is locked in the closed position using a screw mechanism that threadedly attaches the free end 13 to the second end section 10. In these ways, the carabineer 2 can be opened and closed to receive various hooks, ropes and other items.

As noted, the carabineer assembly 1 of FIG. 1 includes a wheel 4 incorporated into the carabineer 2. The wheel 4 can be a single-piece wheel or a multi-piece wheel. When the wheel 4 is a multi-piece wheel, the wheel 4 is split into two or more sections along an axial plane and the sections are configured to mate together to form a wheel 4 having a central bore 22. In certain preferred embodiments, the wheel 4 is split into two halves. FIGS. 2-3 show a wheel 4 including a first wheel half 4a and a second wheel half 4b. The wheel halves 4a, 4b are split along the axial plane 50. The axial plane 50 can be the geometric centerline of the wheel, the geometric centerline being perpendicular to an axis of rotation 8 of the wheel, although this is by no means required. In many cases, the wheel halves 4a, 4b each have a generally semi-circular shape and are mated or fit together to form a wheel 4 having a circular shape.

The wheel halves 4a, 4 b are configured to mate or otherwise fit together along the axial plane 50. In some cases, first wheel half 4a has a first wheel half axial surface 42 and the second wheel half 4b has a second wheel half axial surface 44, wherein the axial surfaces 42, 44 are configured to mate together to form the complete wheel 4. In certain cases, the axial surfaces 42, 44 are mated together so that the surfaces are in close engagement with or abut against each other substantially throughout their entire surface area. In some cases, the axial surfaces 42, 44 are configured to snap-fit or interlock together. The surfaces 42, 44 can interlock together in a permanent or releasable fashion, and a variety of mechanisms for permanently or releasably locking together can be used.

The wheel halves 4a, 4b also form a central bore 22 after they are mated together. In FIGS. 2-3, the first wheel half 4a includes a first bore half 62 and the second wheel half 4b includes a second bore half 64. Specifically, the first wheel half axial surface 42 presents a first bore half 62 and the second wheel half axial surface 44 presents a second bore half 64, so that when the axial surfaces 42, 44 mate together, a wheel 4 having a central bore 22 is formed. The central bore 22 of the wheel 4 provides an opening through which a carabineer frame can be inserted through. In other words, the wheel 4 rotates about an axis of rotation 8 that is defined by the carabineer frame.

In FIG. 1, the wheel 4 rotates about an axis that is defined by the first end section 6. In other words, the first end section 6 serves as an axle for the wheel 4. In other embodiments, one or more portions of the carabineer frame other than (or in addition to) the first end section 6 can serve as the axle of the wheel 4. For example, in some embodiments, the second end section 10 can serve as the axle of the wheel 4. In some preferred embodiments, the first end section 6 can serve as the axle for a first wheel, and the second end section 10 can serve as the axle for a second wheel.

The wheel halves 4a, 4b can take a variety of forms. For example, the wheel halves 4a, 4b can be identical or non-identical to each other. In FIGS. 2-4, the wheel halves 4a, 4b are not identical and the wheel half 4a is a male half and the wheel half 4b is a female half. In other words, the axial surface 42 is configured as a male member including at least one tab 18 and the axial surface 44 is configured as a female member including at least one slot 20. The tab 18 can be inserted into and locked within the slot 20, thereby locking the axial surfaces 42, 44 and thus the wheel halves 4a, 4b together.

In certain embodiments, the tab 18 has a leading edge that can be compressed as it is pressed into the slot 20 and can expand radially outwardly after passing through the slot 20 and into a clearing area. When the tab 18 has expanded radially outwardly, it can present a flange that prevents the tab 18 from withdrawing from the slot 20. In this way, wheel half 4a and wheel half 4b can be assembled to form wheel 4. This assembly can occur with the first end section 6 positioned in the central bore 22, thereby eliminating any need of threading the frame of the carabineer 2 through the central bore 22 of the wheel 4.

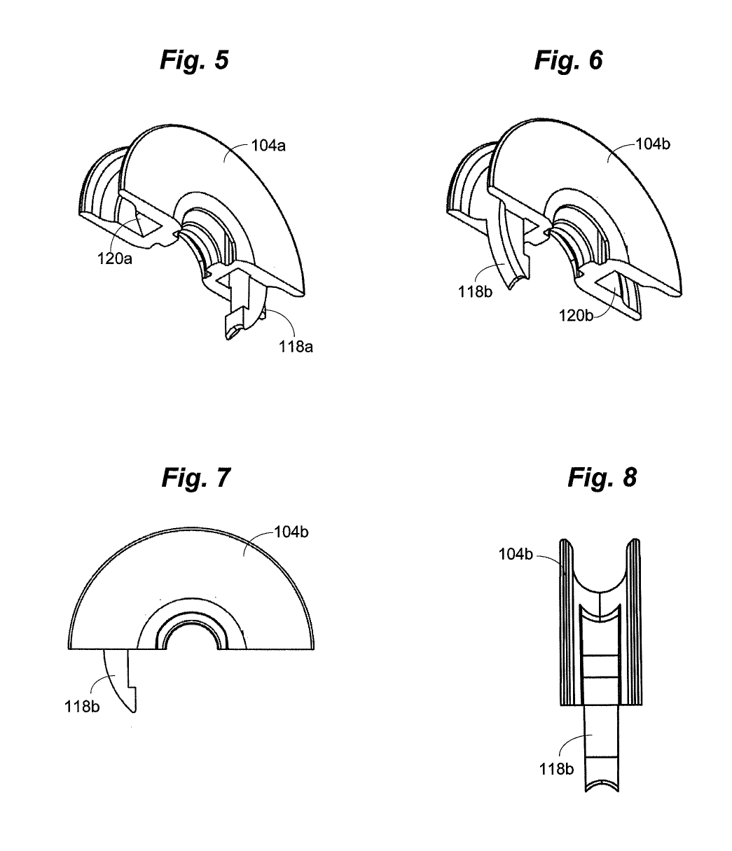

In other embodiments, wheel halves are provided that are identical to each other and each have both a male part and a female part. FIGS. 5-10 illustrate a wheel 4 according to such embodiments. FIG. 5 shows a first wheel half 104a and FIGS. 6-8 shows a second wheel half 104b, wherein the wheel halves are identical to one another. The wheel half 104a includes a first tab 118a and a first slot 120a and the wheel half 104b includes a second tab 118b and a second slot 120b. The first tab 118a inserts into and locks within the second slot 120b and the second tab 118b inserts into and locks within the first slot 120a. Such a configuration provides manufacturing advantages in that the wheel halves 104a, 104b can be identical parts molded from identical molds. The use of only one mold simplifies the manufacturing process and saves the manufacturer time and money. Other segmented wheel configurations are contemplated as being within the scope of the present invention, provided that they combine to form a wheel suitable for use with a carabineer.

The wheel 4 can also include an outer circumference that defines a channel 16 wherein the outer channel is configured to receive and hold a rope in engagement with the wheel 4. In FIGS. 1-4, the channel 16 includes a center portion 70 and two outer flanges 72, 74. The outer flanges 72, 74 also slope so they form a generally concave channel. In many embodiments, the center portion 70 of the channel 16 helps to transfer force to the portion of the carabineer 2 that serves as the wheel axle, while the sides or flanges of the channel 16 help to prevent the rope from slipping off the wheel 4. However, in some embodiments, the outer circumference of the wheel 4 can be generally flat and without a channel, and one or more portions of the carabineer 2 (e.g., the neck region 17) can serve to prevent the rope from slipping off the wheel 4. In any event, the wheel 4 engages a rope and helps to reduce frictional forces between the rope and the carabineer.

The shape of the central bore 22 of the wheel 4 can also be specially configured to accommodate the portion of the carabineer frame that is serving as the axle for the wheel 4. For example, the bore 22 can have a size and shape to accommodate the axle portion of the carabineer frame. The diameter of the central bore 22 can also be configured to accommodate the curvature of the relevant frame portion. In other words, the diameter of the central bore 22 can transition from the sides of the wheel 4 toward the center in accordance with the cross section of the relevant frame portion. In many embodiments, it is desirable to maximize surface contact between the interior side of the portion of the carabineer frame that is serving as the axle and the bore surface of the wheel 4. Doing so evenly distributes the load about the bore surface of the wheel 4, thereby reducing the likelihood of undue wear on the wheel 4 at the portions where the bore surface contacts the carabineer frame. Such a curved/beveled central bore 22 can also aid the wheel 4 in self-centering on the frame of the carabineer 2.

In FIG. 1, the first end section 16 has a generally cylindrical shape. As such, the first bore half 62 and the second bore half 64 each have a generally semi-circular shape, so that a generally circular central bore 22 is formed. However, to accommodate the curvature of the generally cylindrical first end section 16, the bore presents a curved concave bore surface. Here, the bore 22 has a diameter that varies between the two sides of the wheel 4. Generally speaking, the diameter of the bore 22 is greatest at each side of the wheel 4 and is smallest in the plane that is halfway between the two sides of the wheel 4, forming a generally hourglass-like shape. The bore 22 does not have a diameter that remains constant from one side of the wheel 4. Such a constant diameter configuration would likely work but would cause undue stress on the portions of the bore surface that contacted the carabineer frame, thereby potentially compromising the structural integrity of the wheel 4. Thus, it is desirable, but not required, to provide a bore having a variable diameter that accommodates the curvature of the first end section 16.

While wheels have been incorporated into carabineers in the past, embodiments of the present invention are unique in that the axle for the wheel 4 is part of the frame of the carabineer 2. Prior art carabineers that include a wheel incorporate a separate structural component to serve as the axle for the wheel. In other words, the carabineer frame itself does not serve as the axle for the wheel in such prior art carabineers. In such prior art configurations, the carabineer frame was designed the accommodate a wheel, while, as is discussed in greater detail below, embodiments of the present invention incorporate a specially configured wheel 4 into a conventional carabineer 2. Thus, the wheel 4 can be retrofitted onto existing carabineers in order to create a carabineer assembly 1 according to embodiments of the present invention.

Using the existing frame of the carabineer 2, rather than a separate add-on component, as the axle for the wheel 4 provides a number of advantages. For example, it removes any need to alter the proven and safe structure of the existing carabineer. The first end section 6 (or other section serving as the axle) is already designed to bear weight. Incorporating the wheel 4 in this manner places stress on the carabineer frame exactly where it is designed to be placed. In other words, prior art arrangements are undesirable because a separate wheel axle, rather than the carabineer frame, is the structure that bears the load of the rope and any accompanying weight on the rope. This prior art arrangement also presents a safety issue because the separate wheel axle is not designed to withstand high loads like the carabineer frame is. If a prior art wheel ever broke, the rope would slip off, thereby presenting safety issues. However, should the wheel 4 ever break, the rope would still remain supported by the carabineer 2.

Further, the wheel 4 can be provided in a variety of different sizes in order to accommodate different carabineer types and shapes. For example, in some situations, it can be desirable to have the interior of the carabineer 2 as open as possible (e.g., to make clipping it to something else as easy as possible). In such situations, the wheel 4 can be made relatively small so as not to take up much space in the interior of the carabineer 2. On the other hand, in some situations, space considerations in the interior of the carabineer 2 are not as important and the wheel 4 can be made larger to provide an increased mechanical advantage. In some situations, the wheel 4 can be made large enough as to require a notch in the wheel 4 to accommodate movement of side member 12 in order to open the carabineer 2. FIG. 4 illustrates a notch 90 in the wheel that is designed to accommodate movement of the side member 12. Skilled artisans will understand that the notch can be sized and shaped to accommodate a variety of carabineer opening and closing mechanisms. Prior art carabineers with wheels lack this size flexibility, as their wheel axes are positioned in the interior of the carabineer such that their wheels rotate entirely within the interior of the carabineer, meaning that they will always consume more of the interior space.

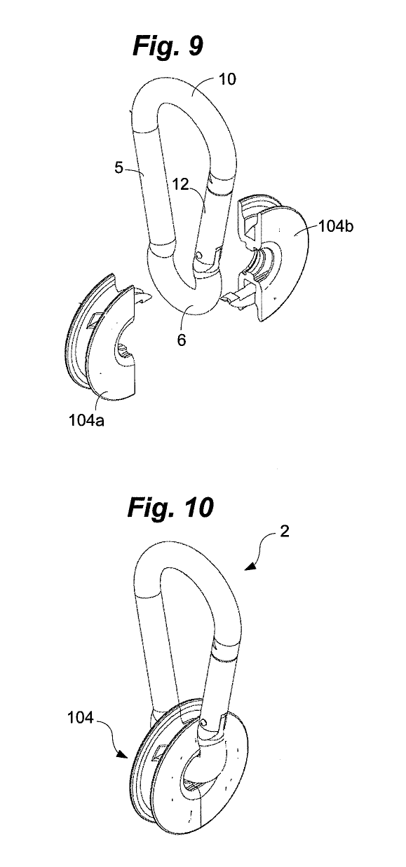

Additionally, using the frame of the carabineer 2 as the axle for the wheel 4 can provide manufacturing challenges. It can be extremely difficult to attempt to thread the frame of the carabineer 2 through the central bore 22 of a fully assembled wheel 4 in order to properly position the wheel 4 relative to the first end section 6. Such a technique would prove especially challenging in the neck region 17 of the carabineer. For example, the first end region 6 has a width. If the wheel 4 has a diameter that is equal to or larger than the width, it would be extremely difficult to thread the first end region 6 through the central bore 22. Accordingly, a two piece or multi-piece structure of the wheel 4 is advantageous for use with a carabineer having a shape with sharp angles and for a carabineer having an angular neck region. In other words, a multi-piece wheel 4 is advantageous when the wheel has a diameter and the first end section has a width wherein the diameter is equal to or larger than the width. This advantage is best illustrated in FIGS. 9 and 10. Wheel halves 104a, 104b are positioned on each side of the narrow end region 6 of the carabineer 2, as shown in FIG. 9 and then are locked together in position on the end region 6, as shown in FIG. 10.

In certain embodiments, the carabineer assembly 1 can be used in connection with a block-and-tackle. The carabineer assembly 1 can fixedly attach on one end (e.g., second end section 10) to an object to be lifted/held. A rope can engage a wheel 4 on the other end of the carabineer assembly 1 (e.g., first end section 6). The rope can also engage a tensioning device (e.g., the tensioning device shown and described in commonly assigned U.S. Patent Application No. 61/360,286, which was filed on Jun. 30, 2010, and which is hereby incorporated in its entirety). The tensioning device can provide a mechanical advantage in raising/lowering objects. Such a block-and-tackle can have advantageous application in the hydroponics industry, where expensive equipment (e.g., lights and fans) are being raised and lowered, and the closed hook of a carabineer 2 significantly reduces the likelihood of such equipment being dropped and damaged.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

What is claimed is:

1. A carabineer assembly, comprising:
a wheel comprising a first wheel half and a second wheel half, wherein the first wheel half has a first wheel half axial surface and the second wheel half has a second wheel half axial surface, wherein the first wheel half axial surface comprises a first bore half and the second wheel half axial surface comprises a second bore half, wherein the first wheel half axial surface and the second wheel half axial surface are configured to mate together thereby forming a wheel having a central bore; and
a carabineer having a frame, wherein a portion of the frame forms a wheel axle that extends through the central bore.

2. The carabineer assembly of claim 1 wherein the first wheel half and the second wheel half each have a semicircular shape and the first bore half and the second bore half each have a semicircular shape.

3. The carabineer assembly of claim 1 wherein the first wheel half and the second wheel half are substantially identical and wherein the first wheel half axial surface includes a first tab and a first slot and the second wheel half axial surface includes a second tab and a second slot, wherein the first tab inserts into and locks within the second slot and the second tab inserts into and locks within the first slot.

4. The carabineer assembly of claim 1 wherein central bore has a variable diameter configured to accommodate the curvature of the portion of the carabineer frame that forms a wheel axle.

5. The carabineer assembly of claim 4 wherein the portion of the carabineer frame that forms a wheel axle has a cylindrical curvature and the central bore presents a concave surface.

6. The carabineer assembly of claim 1 wherein the wheel has an outer circumference that defines an outer channel, wherein the outer channel is configured to receive a rope.

7. The carabineer assembly of claim 1 wherein the frame includes a first end section, a second end section and two side members, wherein the first end section forms the wheel axle that extends through the central bore of the wheel and wherein one of the side members is movable towards and away from the wheel.

8. The carabineer assembly of claim 7 wherein the wheel presents a notch, wherein the notch has a size and shape configured to allow a portion of the movable side member to pass through.

9. The carabineer assembly of claim 7 wherein the first end section includes a neck region that is narrower than any region of the second section.

10. The carabineer assembly of claim 7 wherein the wheel has a diameter and the first end section has a width, wherein the diameter is equal to or larger than the width.

11. A wheel assembly, comprising:
a wheel comprising a first wheel half and a second wheel half, wherein the first wheel half and the second wheel half have a semicircular shape, wherein the first wheel half has a first wheel half axial surface and the second wheel half has a second wheel half axial surface, wherein the first wheel half axial surface comprises a first bore half and the second wheel half axial surface comprises a second bore half, wherein the first bore half and the second bore half each have a semicircular shape, wherein the first wheel half axial surface and the second wheel half axial surface are configured to mate together thereby forming a circular wheel having a central circular bore, wherein the central circular bore presents a concave surface, wherein the circular wheel has an outer circumference that defines an outer channel configured to receive a rope, and wherein the circular wheel presents a notch that extends inward from the outer circumference.

12. The wheel assembly of claim 11 wherein the first wheel half and the second wheel half are not identical, and wherein first wheel half axial surface includes at least one tab and the second wheel half axial surface includes at least one slot, wherein the tab inserts into and locks within the slot.

13. The wheel assembly of claim 11 wherein the first wheel half and the second wheel half are substantially identical and wherein the first wheel half axial surface includes a first tab and a first slot and the second wheel half axial surface includes a second tab and a second slot, wherein the first tab inserts into and locks within the second slot and the second tab inserts into and locks within the first slot.

14. A carabineer assembly, comprising:
a wheel having a central bore;
a carabineer having a frame, wherein the frame includes a first end section, a second end section and two side members;
wherein the first end section forms a wheel axle that extends through the central bore.

15. The carabineer assembly of claim 14 wherein the first end section includes a neck region that is narrower than any region of the second end section.

16. The carabineer assembly of claim 14 wherein the wheel has a diameter and the first end section has a width, wherein the diameter is equal to or larger than the width.

17. The carabineer assembly of claim 14 wherein the wheel is split into two or more sections along an axial plane, wherein the sections are configured to mate together to form a wheel having a central bore.

18. The carabineer of claim 17 wherein the wheel is split into two halves along an axial plane, wherein the two halves are configured to mate together to form a wheel having a central bore.

19. The carabineer assembly of claim 18 wherein the two halves each have a semicircular shape and wherein the two halves each comprise a semicircular bore, wherein the two halves are configured to mate together to form a circular wheel having a circular central bore.

20. The carabineer assembly of claim 19 wherein central circular bore presents a concave surface.

21. The carabineer assembly of claim 18 wherein the two halves are substantially identical and wherein the one half includes a first tab and a first slot and the other half includes a second tab and a second slot, wherein the first tab inserts into and locks within the second slot and the second tab inserts into and locks within the first slot.

22. The carabineer assembly of claim 14 wherein the circular wheel has an outer circumference that defines an outer channel, wherein the outer channel is configured to receive a rope.

23. The carabineer assembly of claim 14 wherein one of the side members is movable towards and away from the wheel and the wheel presents a notch, wherein the notch has a size and shape configured to allow a portion of the movable side member to pass through.
